(19) United States
(12) Patent Application Publication
(10) Pub. No.: US 2004/0081778 A1
(43) Pub. Date: Apr. 29, 2004

(54) Laminate package for an energy storage device

(76) Inventor: Rory Albert James Pynenburg, Hillsboro, OR (US)

Correspondence Address: KENYON & KENYON, 1500 K STREET, N.W., SUITE 700, WASHINGTON, DC, 20005, US

(21) Appl. No.: 10/724,596

(22) Filed: Dec. 1, 2003

Related U.S. Application Data
(63) Continuation of application No. 10/070,385, filed on May 21, 2002, now abandoned.
Application No. 10/070,385 is a 371 of international application No. PCT/AU01/00838, filed on Jul. 10, 2001.

(30) Foreign Application Priority Data
Jul. 10, 2000 (AU) PQ 8700

(51) Int. Cl. F16L 1/00

(52) U.S. Cl. 428/34.1

(57) ABSTRACT

A laminate package (1) for an energy storage device in the form of a supercapacitor (2) that has two terminals (3, 4). Package (1) includes an inner barrier layer (5) of polyethylene (PE) for defining a cavity (6) to contain device (2). Layer (5) has two opposed edges (9) that are sealingly engaged with each other and from between which terminals (3, 4) extend from the cavity. A sealant layer (11) of Nucrel™ resin is disposed intermediate layer and terminals (3). An outer barrier layer (12) is bonded to layer (5) and has a metal layer (13) which is aluminium.

### FIELD OF THE INVENTION

The present invention relates to a laminate package and in particular to a laminate package for a charge storage device.

The invention has been developed primarily for packaging supercapacitors and will be described hereinafter with reference to that application. However, the invention is not limited to that particular field of use and is also applicable to other energy storage devices such as batteries. The invention is also particularly suited to wet cell batteries such as those generally referred to as Lithium ion, Lithium polymer, Nickel Metal Hydride or Nickel Cadmium batteries.

### DISCUSSION OF THE PRIOR ART

Many batteries and supercapacitors make use of an electrolyte. These electrolytes are generally corrosive or otherwise dangerous and it is important that they do not seep or leak from the device. It is also important, for proper device operation, that oxygen, water or other substances do not contaminate the electrolyte. Both these factors have encouraged the use of sealed packages to prevent the ingress and egress of material to and from the device.

Energy storage devices generally have two external electrodes for allowing electrical connection of the device to the associated load or circuitry. The need for the terminals to extend from the inside to the outside of the package compromises the effectiveness of the seal that has been achieved. Some attempts have been made, with limited success, to affect the sealing of the package through use of a plastics laminate which is heat sealed together with the terminals. For example, U.S. Pat. No. 5,445,856 discloses a laminate package for a battery that includes many different layers.

The limitations of the prior art packages are exacerbated by the advent of higher current demands from charge storage devices, and particularly from supercapacitors. These demands require the use of thicker terminals so that the equivalent series resistance (esr) of the relevant supercapacitor or the internal resistance of the relevant battery is minimised. The prior art packages, however, do not offer suitable properties to allow the necessary sealing about these thicker terminals.

It is also known for laminate packaging to include a metal layer, and for failure of the packaging to occur due to current leakage or shorts between the terminal and that metal layer.

Any discussion of the prior art throughout the specification should in no way be considered as an admission that such prior art is widely known or forms part of common general knowledge in the field.

### DISCLOSURE OF THE INVENTION

It is an object of the present invention to overcome or ameliorate at least one of the disadvantages of the prior art, or to provide a useful alternative.

According to a first aspect of the invention there is provided a laminate package for an energy storage device having two terminals, the package including:

an inner barrier layer for defining a cavity to contain the energy storage device, the inner barrier layer having two opposed portions that are sealingly engaged with each other and from between which the terminals extend from the cavity;

a sealant layer being disposed intermediate the inner barrier layer and the terminals; and

an outer barrier layer bonded to the inner barrier layer and having a metal layer.

Preferably, the sealant layer is Nucrel™ resin containing between about 5% and 10% ethylene acrylic acid. More preferably, the adhesive contains about 6% to 9% of ethylene acrylic acid.

In other embodiments, the sealant layer contains one of: maleic anhydride; maleic acid; one or more anhydride grafted polyolefins; and one or more acid modified polyolefins.

Preferably also, the metal layer includes an aluminium sheet. More preferably, the aluminium layer is less than 30 μm thick. Even more preferably, the aluminium layer is less than 25 μm thick. In some embodiments the aluminium layer is less than 20 μm thick.

In a preferred form the outer barrier layer includes a first plastics layer bonded to the outside of the metal layer. More preferably, the plastics layer is PET. Even more preferably, the plastics layer is less than 40 μm thick. Preferably also, the plastics layer is less than 30 μm thick.

Preferably also, the outer barrier layer includes a second plastics layer bonded to the inside of the metal layer. More preferably, the second plastics layer is selected from the group consisting of: PET; polyamide; polyvinylidene chloride (PVdC); and polypropylene (PP).

Preferably, the second plastics layer is less than about 20 μm thick. More preferably, the second plastics layer is less than about 15 μm thick.

Preferably also, the inner barrier layer includes a third plastics layer that is bonded to the inside of the outer barrier layer. More preferably, the third plastics layer is heat sealable and is selected from the group consisting of: PVdC; and polyethylene (PE).

Preferably also, the third plastics layer is less than about 40 μm thick. More preferably, the third plastics layer is less than about 30 μm thick.

Preferably, the outer barrier layer and the inner barrier layer include a first melting point and a second melting point respectively, where the first melting point is higher than the second melting point.

In a preferred form, the package is formed from a single sheet of laminate material that is folded along its length so that the inner barrier layer is inner-most. More preferably, at least three of the edges of the folded sheet are abutted and heat sealed. In other embodiments the package is formed from two separate opposed sheets of laminate which are abutted and heat sealed about their entire adjacent peripheries.

Preferably, the thickness of the laminate in the portions containing the sealant is less than 100 μm. That is, the distance between the outside of the outer barrier layer and the inside of the sealant is less than 100 μm.

Preferably also, the terminals are aluminium and have a thickness of at least 50 μm. However, in other embodiments the terminals have a thickness of at least 100 μm. In some embodiments where particularly high currents are drawn the terminals have a thickness of about 500 μm.

In a preferred form the terminal are heated to assist the heat sealing of the inner barrier layers.

According to a second aspect of the invention there is provided a method of producing a laminate package for an energy storage device having two terminals, the method including:

defining, with an inner barrier layer, a cavity to contain the energy storage device, the inner barrier layer having two opposed portions that are sealingly engaged with each other and from between which the terminals extend from the cavity;

disposing a sealant layer intermediate the inner barrier layer and the terminals; and

bonding an outer barrier layer to the inner barrier layer, the outer barrier layer having a metal layer.

According to a third aspect of the invention there is provided a laminate package for an energy storage device having two terminals, the package including:

an inner barrier layer for defining a cavity to contain the energy storage device;

a sealant layer being disposed between, and being sealing engaged with, the inner barrier layer and the terminals; and

an outer barrier layer bonded to the inner barrier layer and having a metal layer, wherein the package sealingly contains the energy storage device and the terminals are accessible from outside the package for allowing external electrical connection to the energy storage device.

Preferably, the outer barrier layer and the inner barrier layer include a first melting point and a second melting point respectively, where the first melting point is higher than the second melting point.

According to a fourth aspect of the invention there is provided a method of forming a laminate package for an energy storage device having two terminals, the method including:

containing the energy storage device in a cavity defined by an inner barrier layer;

disposing a sealant layer between, and in sealing engagement with, the inner barrier layer and the terminals; and

bonding an outer barrier layer to the inner barrier layer that has a metal layer, wherein the package sealingly contains the energy storage device and the terminals are accessible from outside the package for allowing external electrical connection to the energy storage device.

According to a fifth aspect of the invention there is provided a laminate package for an energy storage device having two terminals, the package including:

an inner barrier layer for defining a cavity to contain the energy storage device, the inner barrier layer having a first melting point;

a sealant layer being disposed between, and being sealing engaged with, the inner barrier layer and the terminals, the sealant layer having a second melting point that is less than the first melting point; and

an outer barrier layer bonded to the inner barrier layer and having a metal layer, wherein the outer barrier layer having a third melting point that is greater than the first melting point.

According to a sixth aspect of the invention there is provided a method for producing a laminate package for an energy storage device having two terminals, the package including:

defining, with an inner barrier layer, a cavity to contain the energy storage device, the inner barrier layer having a first melting point;

disposing a sealant layer between, and being sealing engaged with, the inner barrier layer and the terminals, the sealant layer having a second melting point that is less than the first melting point; and

bonding an outer barrier layer to the inner barrier layer, wherein the outer barrier layer has a metal layer and a third melting point that is greater than the first melting point.

According to a seventh aspect of the invention there is provided a laminate package for an energy storage device having two terminals, the package including:

an inner barrier layer for defining a cavity to contain the energy storage device, the inner barrier layer having a first melting point;

a sealant layer being disposed between, and being sealing engaged with, the inner barrier layer and the terminals, the sealant layer having a second melting point that is less than the first melting point; and

an outer barrier layer bonded to the inner barrier layer and having a metal layer, wherein the outer barrier layer having a third melting point that is greater than the first melting point.

Preferably, the sealing engagement between the sealing layer and both the terminals and the inner barrier layer is affected by thermal means. More preferably, the thermal means applies thermal energy to the package to soften the sealant layer preferentially to the inner barrier layer. Even more preferably, the application of the thermal energy softens the inner barrier layer preferentially to the outer barrier layer.

Preferably also, the sealing engagement is also affected by the combination of the thermal energy and compressive forces being applied to the layers. More preferably, that combination does not bring any one of the terminals into direct contact with the metal layer.

According to an eighth aspect of the invention there is provided a method of producing a laminate package for an energy storage device having two terminals, the method including:

defining a cavity, with an inner barrier layer, to contain the energy storage device, the inner barrier layer having a first melting point;

disposing a sealant layer between, and being sealing engaged with, the inner barrier layer and the terminals, the sealant layer having a second melting point that is less than the first melting point; and

bonding an outer barrier layer to the inner barrier layer, wherein the outer layer has a metal layer and a third melting point that is greater than the first melting point.

### BRIEF DESCRIPTION OF THE DRAWINGS

Preferred embodiments of the invention will now be described, by way of example only, with reference to the accompanying drawings in which:

FIG. 1 is a schematic partially cut-away perspective view of a laminate package for an energy storage device according to the invention;

FIG. 2 is an enlarged schematic top view of one of the terminals of the energy storage device of FIG. 1;

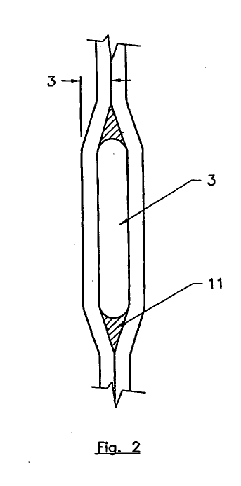

FIG. 3 is a schematic cross-section taken along line 3—3 of FIG. 2; and

FIG. 4 is a schematic cross-section of an alternative laminate.

### DETAILED DESCRIPTION OF EMBODIMENTS OF THE INVENTION

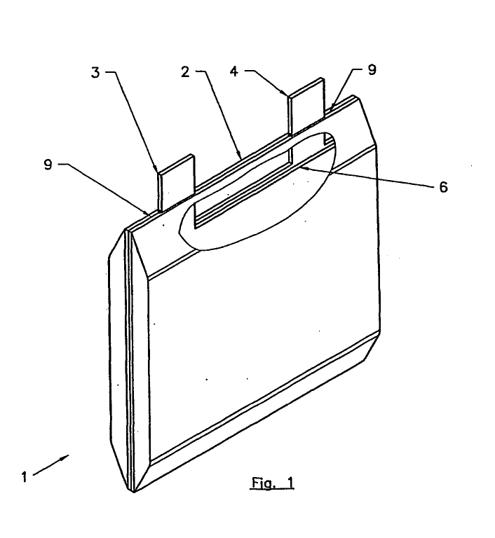

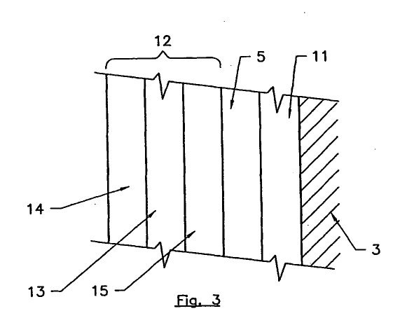

Referring to the drawings, and in particular to FIG. 1, there is illustrated a laminate package 1 for an energy storage device in the form of a supercapacitor 2 that has two terminals 3 and 4. As best shown from the combination of FIGS. 1 and 3, package 1 includes an inner barrier layer 5 of polyethylene (PE) for defining a cavity 6 to contain device 2. Layer 5 has two opposed edges 9 that are sealingly engaged with each other and from between which terminals 3 and 4 extend from the cavity. A sealant layer 11 of Nucrel™ resin is disposed intermediate layer and terminals 3. An outer barrier layer 12 is bonded to layer 5 and has a metal layer 13 which is aluminium.

Layer 11 is Nucrel™ resin containing about 6% of ethylene acrylic acid (EAA). In other embodiments, however, different proportions of EAA are used, although it is preferred that this remains in the range of about 5% to 10%.

Layer 13 is about 20 μm thick and constructed from a single sheet of aluminium. This provides a barrier to the ingress of contaminants through the laminate into cavity 6 and an egress of electrolyte from the cavity.

In other embodiments layer 13 is of a different thickness although preferably less than 30 μm thick.

Layer 12 also includes a first plastics layer 14 of PET that is bonded to the outside of layer 13. Layer 14 is about 30 μm thick, although in other embodiments it is about 40 μm thick.

Layer 12 also includes a second plastics layer 15 of polypropylene (PP) that is bonded to the inside of the layer 13. In other embodiments layer 15 is selected from the group consisting of: PET; polyamide; and polyvinylidene chloride (PVdC).

Layer 15 is about 15 μm thick, although in other embodiments layer 15 is about 20 μm thick.

As shown, layer 5 is bonded to the inside of layer 15 and is about 30 μm thick. In alternative embodiments, however, layer 15 is about 40 μm thick

Layer 5 is heat sealable and, as such, a variety of alternative materials are available. For example, in other embodiments, layer 5 is comprised of a material selected from the group consisting of: PVdC; and polyethylene (PE).

Layer 15 and layer 5 include a first melting point and a second melting point respectively, where the first melting point is higher than the second melting point.

Package 1 is formed from a single sheet of laminate material that is folded along its length so that layer 5 is inner-most. In the portions immediately adjacent terminals 3 and 4 the additional layer 11 is included. The three opposed edges of the folded sheet are then abutted and heat sealed to sandwich the terminals. Layer 11 is particularly good at sealing terminals 3 and 4 to the adjacent layer 5 as well as offering a barrier to the passage of contaminants into the cavity of electrolyte from the cavity.

In other embodiments the package is formed from two separate opposed sheets of laminate which are abutted and heat sealed about their entire adjacent peripheries.

The thickness of the laminate in the portions containing the sealant is less than 100 μm. That is, the distance between the outside of layer 14 and the inside of layer 11 is less than 100 μm.

Terminals 3 and 4 are aluminium and have a thickness of about 500 μm and a width of about 8 mm. These terminals are intended to carry short term peak currents of about 100 Amps. In devices catering for lower peak currents the terminals have a thickness of about 100 μm.

Terminals 3 and 4 are heated during the heat sealing of layer 5 to assist the formation of layer 11.

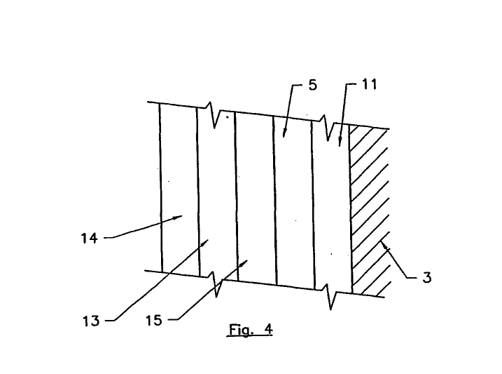

An alternative laminate is shown in FIG. 4 where corresponding features are denoted by corresponding reference numerals. In this embodiment the layers are constituted as follows:

layer 5: PVdC;

layer 11: Nucrel™ resin;

layer 13: aluminium;

layer 14: PET; and

layer 15: PET.

The thin laminate of the preferred embodiments offers the necessary barrier properties to the ingress and egress of materials into and from the cavity particularly in the area around the terminals. That is, the laminate is thin and more capable of bending into conformity with the terminal. The low melting point of layer 5, together with its high vicat softening temperature, also greatly assists in this regard

Moreover, as layer 5 has a lower melting point than layer 15 there is a significant reduction in the risk of shorting the tabs to the aluminium layer during the heat sealing operation.

A further embodiment of the invention is illustrated in the follow example. The layers of the embodiment are described starting from the outside layer of the package and progressing through to the inside layer of the package.

1) A polyamide or polyester. Preferably, nylon or PET. This has two main benefits of:

a) being open to corona treatment as a preparation for accepting printing; and

b) it slows down the rate of ingress of oxygen and other contaminants through the laminate.

2) A tie layer. Preferably this is a polyurethane.

3) An aluminium layer, or other metal. Aluminium is preferred as it is relatively cheap and readily available. The preferred thicknesses of the aluminium are in the range of about 20 to 50 μm and more preferably in the range of 40 to 50 μm. The sheet is annealed so that it is malleable, which has two main advantages, these being:

a) by being more malleable the laminate will fold better and better hold it's folded shape. This, in turn, aids the sealing of the package;

b) the thicker the aluminium or metal, the less the number of pin holes in it. Hence there being less chance of oxygen, water and other contaminants permeating through the metal layer.

4) A tie layer.

5) A polymer to provide electrical shorting protection. Preferably, use is made of a polyolefin such as one of polyethylene or polypropylene or, alternatively, of PET or nylon. Other intrinsically non-conductive polymers are used in other embodiments.

6) A tie layer.

7) A sealant layer. This will be of varying thickness depending upon the nature of the other layers. Preferably, use is made of a grade of Nucrel™ with acrylic acid content of about 10%. However, in other embodiments, use is made of a maleic anhydride grafted polypropylene. In further embodiments use is made of an acid etched polyolefin. The thickness of the sealant layer is heavily dependent upon the thickness of the terminals.

All layers are preferably between 15 and 100 μm in thickness, except for the tie layers, which are generally between 1 to 10 μm in thickness.

Some specific laminates and layer thicknesses follow, again with the layers being stated from the outermost to the innermost.

| | |
|---|---|
| Layer Material | Thickness (microns) |

Example 1

| | |
|---|---|
| PET | 23 |
| TIE | 3 |
| Al | 29 |
| PET | 12 |
| TIE | 3 |
| PE | 30 |
| TIE | 1 |
| Nucrel | 30 |

Example 2

| | |
|---|---|
| PET | 12 |
| TIE | 3 |
| Al | 29 |
| Nucrel | 15 |

Example 3

| | |
|---|---|
| PET | 12 |
| TIE | 3 |
| Al | 25 |
| Nucrel | 15 |
| PET | 12 |
| Nucrel | 30 |

Although the invention has been described with reference to specific examples it will be appreciated by those skilled in the art that it may be embodied in many other forms.

1. A laminate package for an energy storage device having two terminals, the package including:
an inner barrier layer for defining a cavity to contain the energy storage device, the inner barrier layer having two opposed portions that are sealingly engaged with each other and from between which the terminals extend from the cavity;
a sealant layer being disposed intermediate the inner barrier layer and the terminals; and
an outer barrier layer bonded to the inner barrier layer and having a metal layer.

2. A package according to claim 1 wherein the sealant layer is Nucrel™ resin containing between about 5% and 10% ethylene acrylic acid.

3. A package according to claim 2 wherein the sealant layer contains about 6% to 9% of ethylene acrylic acid.

4. A package according to claim 1 wherein the sealant layer contains one of: one or more maleic anhydrides; maleic acid; one or more anhydride grafted polyolefins; and one or more acid modified polyolefins.

5. A package according to claim 1 wherein the metal layer includes an aluminium sheet.

6. A package according to claim 5 wherein the aluminium sheet is less than 30 μm thick.

7. A package according to claim 5 wherein the aluminium sheet is less than 25 μm thick.

8. A package according to claim 5 wherein the aluminium layer is less than 20 μm thick.

9. A package according to claim 1 wherein the outer barrier layer includes a first plastics layer bonded to the outside of the metal layer.

10. A package according to claim 9 wherein the plastics layer is PET.

11. A package according to claim 9 wherein the plastics layer is less than 40 μm thick.

12. A package according to claim 9 wherein the plastics layer is less than 30 μm thick.

13. A package according to claim 9 wherein the outer barrier layer includes a second plastics layer bonded to the inside of the metal layer.

14. A package according to claim 13 wherein the second plastics layer is selected from the group consisting of: PET; polyamide; polyvinylidene chloride (PVdC); and polypropylene (PP).

15. A package according to claim 13 wherein the second plastics layer is less than about 20 μm thick.

16. A package according to claim 13 wherein the second plastics layer is less than about 15 μm thick.

17. A package according to claim 13 wherein the inner barrier layer includes a third plastics layer that is bonded to the inside of the outer barrier layer.

18. A package according to claim 17 wherein the third plastics layer is heat sealable and is selected from the group consisting of: PVdC; and polyethylene (PE).

19. A package according to claim 17 wherein the third plastics layer is less than about 40 μm thick.

20. A package according to claim 17 wherein the third plastics layer is less than about 30 μm thick.

21. A package according to claim 1 wherein the outer barrier layer and the inner barrier layer include a first melting point and a second melting point respectively, where the first melting point is higher than the second melting point.

22. A package according to claim 1 wherein the package is formed from a single sheet of laminate material that is folded along its length so that the inner barrier layer is inner-most.

23. A package according to claim 22 wherein at least three of the edges of the folded sheet are abutted and heat sealed.

24. A package according to claim 1 wherein the package is formed from two separate opposed sheets of laminate which are abutted and heat sealed about their entire adjacent peripheries.

25. A package according to claim 1 wherein the thickness of the laminate in the portions containing the sealant is less than 100 μm.

26. A package according to claim 1 wherein the terminals are aluminium and have a thickness of at least 50 μm.

27. A package according to claim 1 wherein the terminals have a thickness of at least 100 μm.

28. A package according to claim 1 wherein the terminals have a thickness of about 500 μm.

29. A package according to claim 1 wherein the terminals are heated to assist the heat sealing of the inner barrier layers.

30. A method of producing a laminate package for an energy storage device having two terminals, the method including:
defining, with an inner barrier layer, a cavity to contain the energy storage device, the inner barrier layer having two opposed portions that are sealingly engaged with each other and from between which the terminals extend from the cavity;
disposing a sealant layer intermediate the inner barrier layer and the terminals; and
bonding an outer barrier layer to the inner barrier layer, the outer barrier layer having a metal layer.

31. A laminate package for an energy storage device having two terminals, the package including:
an inner barrier layer for defining a cavity to contain the energy storage device;
a sealant layer being disposed between, and being sealing engaged with, the inner barrier layer and the terminals; and
an outer barrier layer bonded to the inner barrier layer and having a metal layer, wherein the package sealingly contains the energy storage device and the terminals are accessible from outside the package for allowing external electrical connection to the energy storage device.

32. A package according to claim 31 wherein the outer barrier layer and the inner barrier layer include a first melting point and a second melting point respectively, where the first melting point is higher than the second melting point.

33. A method of forming a laminate package for an energy storage device having two terminals, the method including:
containing the energy storage device in a cavity defined by an inner barrier layer,
disposing a sealant layer between, and in sealing engagement with, the inner barrier layer and the terminals; and
bonding an outer barrier layer to the inner barrier layer that has a metal layer, wherein the package sealingly contains the energy storage device and the terminals are accessible from outside the package for allowing external electrical connection to the energy storage device.

34. A laminate package for an energy storage device having two terminals, the package including:
an inner barrier layer for defining a cavity to contain the energy storage device, the inner barrier layer having a first melting point;
a sealant layer being disposed between, and being sealing engaged with, the inner barrier layer and the terminals, the sealant layer having a second melting point that is less than the first melting point; and
an outer barrier layer bonded to the inner barrier layer and having a metal layer, wherein the outer barrier layer having a third melting point that is greater than the first melting point.

35. A method for producing a laminate package for an energy storage device having two terminals, the package including:
defining, with an inner barrier layer, a cavity to contain the energy storage device, the inner barrier layer having a first melting point;
disposing a sealant layer between, and being sealing engaged with, the inner barrier layer and the terminals, the sealant layer having a second melting point that is less than the first melting point; and
bonding an outer barrier layer to the inner barrier layer, wherein the outer barrier layer has a metal layer and a third melting point that is greater than the first melting point.

36. A laminate package for an energy storage device having two terminals, the package including:
an inner barrier layer for defining a cavity to contain the energy storage device, the inner barrier layer having a first melting point;
a sealant layer being disposed between, and being sealing engaged with, the inner barrier layer and the terminals, the sealant layer having a second melting point that is less than the first melting point; and
an outer barrier layer bonded to the inner barrier layer and having a metal layer, wherein the outer barrier layer having a third melting point that is greater than the first melting point.

37. A package according to claim 36 wherein the sealing engagement between the sealing layer and both the terminals and the inner barrier layer is affected by thermal means.

38. A package according to claim 37 wherein the thermal means applies thermal energy to the package to soften the sealant layer preferentially to the inner barrier layer.

39. A package according to claim 38 wherein the application of the thermal energy softens the inner barrier layer preferentially to the outer barrier layer.

40. A package according to claim 37 wherein the sealing engagement is also affected by the combination of the thermal energy and compressive forces being applied to the layers.

41. A method of producing a laminate package for an energy storage device having two terminals, the method including:
defining a cavity, with an inner barrier layer, to contain the energy storage device, the inner barrier layer having a first melting point;
disposing a sealant layer between, and being sealing engaged with, the inner barrier layer and the terminals, the sealant layer having a second melting point that is less than the first melting point; and
bonding an outer barrier layer to the inner barrier layer, wherein the outer layer has a metal layer and a third melting point that is greater than the first melting point.
